(19) United States
(12) Patent Application Publication
(10) Pub. No.: US 2017/0282342 A1
(43) Pub. Date: Oct. 5, 2017

(54) SHOCK ABSORBING HAMMER

(71) Applicant: SING RAY CORPORATION, TAICHUNG CITY (TW)

(72) Inventor: Benny KUO, TAICHUNG CITY (TW)

(21) Appl. No.: 15/090,902

(22) Filed: Apr. 5, 2016

(51) Int. Cl. B25D 1/12

(52) U.S. Cl. CPC B25D 1/12

(57) ABSTRACT

A shock absorbing hammer includes a head and a handle connected to the head. At least one recessed portion is located on each cheek of the head and abutted to the handle.

### BACKGROUND OF THE INVENTION

### 1. Field of the Invention

The present invention relates to hammer, and more particularly, to a shock absorbing hammer having recessed portions formed on the cheeks of the head, achieving damping and effort-saving effects.

### 2. Description of the Related Art

A conventional hammer, for example, the effort-saving hammer 1 of Taiwan Patent M400924 (see its specification and the annexed FIG. 2) comprises a head 2, and a handle 6 connected to the head 2. The head 2 has multiple holes 7 cut therethrough to alter the structure, reducing the transfer of the amount of the generated counterforce to the handle 6 upon each operation of the effort-saving hammer to hit against an object and achieving damping and effort-saving effects.

However, the fabrication of the aforesaid prior art hammer design is complicated because it needs to make holes 7 through the head 2.

### SUMMARY OF THE INVENTION

The present invention has been accomplished under the circumstances in view. It is the main object of the present invention to provide a shock absorbing hammer, which achieves damping and effort-saving effects and facilitates fabrication.

To achieve this and other objects of the present invention, a shock absorbing hammer comprises a head, and a handle connected to the head, wherein the head has at least one recessed portion located on the outer surface thereof and abutted to the handle.

The design of the at least one recessed portion on the head can reduce the transfer of the generated counterforce to the handle upon each operation of the hammer to hit against an object, thereby achieving damping and effort-saving effects. Because it is easy to form the at least one recessed portion on the head, the fabrication of the hammer is relatively simple.

In one aspect, the head of the shock absorbing hammer has two opposite cheeks, and two recessed portions respectively located on the cheeks and abutted to the handle to enhance the damping effect.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic side view of a part of a shock absorbing hammer in accordance with a first embodiment of the present invention.

FIG. 2 is a sectional view taken along line 2-2 of FIG. 1.

FIG. 3 is a schematic side view of a part of a shock absorbing hammer in accordance with a second embodiment of the present invention.

### DETAILED DESCRIPTION OF THE INVENTION

For better understanding of the features of the present invention, two embodiments are provided hereinafter with reference to the annexed drawings, in which the first embodiment is exemplified as a nail hammer; the second embodiment is exemplified as a ball-peen hammer.

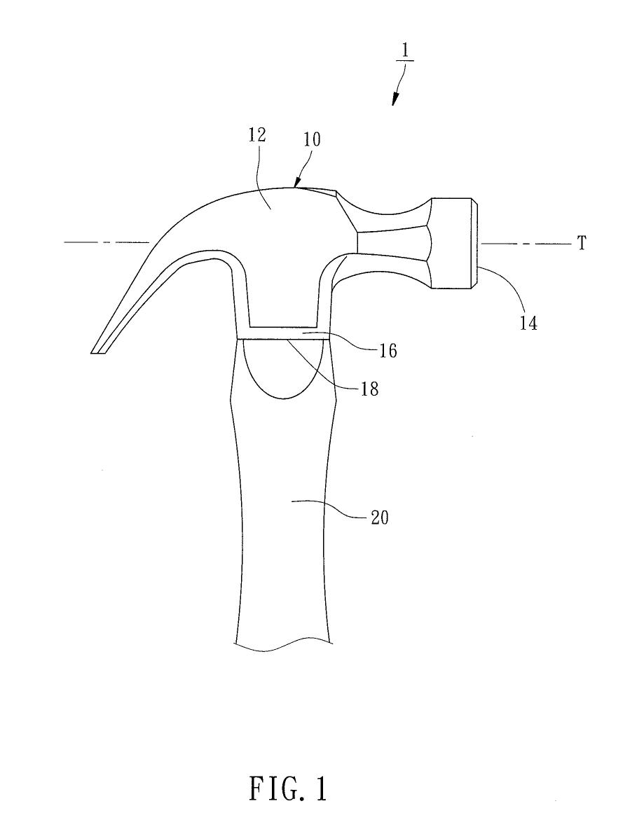

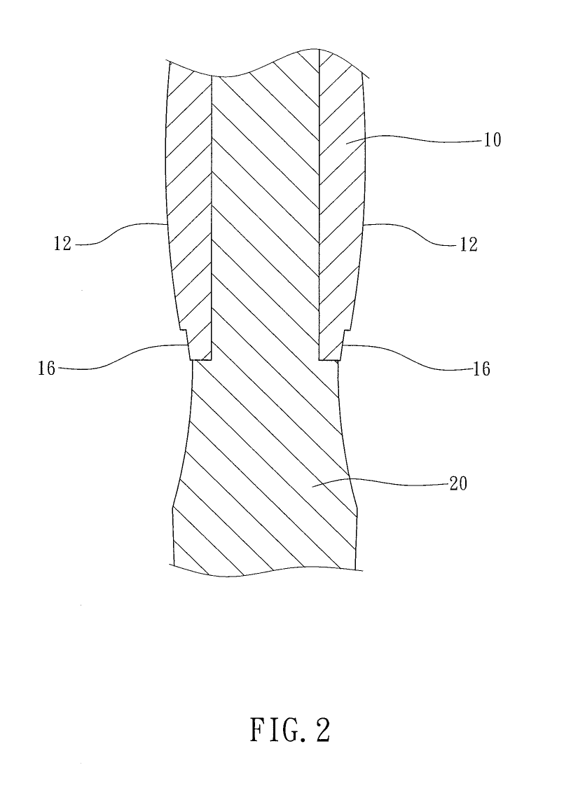

Referring to FIGS. 1 and 2, a shock absorbing hammer 1 in accordance with the first embodiment of the present invention is shown. The shock absorbing hammer 1 comprises a head 10 and a handle 20. The handle 20 is fixedly connected to a middle part of the head 10. Further, the head 10 comprises two opposite cheeks 12, a bell face 14, and two recessed portions 16 respectively located on the cheeks 12 and abutted to the handle 20. In this embodiment, the recessed portions 16 have a substantially stepped cross section extended along an edge 18 of the head 10.

The formation of the recessed portion 16 in the head 10 of the shock absorbing hammer 1 reduces the mass of the part of the head 10 adjacent to the handle 20, and thus, when the user operates the shock absorbing hammer 1 to hit against an object, a major part of the counterforce thus produced will be transferred through the bell face 14 along the longitudinal direction T of the head 10, and only a small amount of the counterforce will be transferred through the recessed portions 16 to the handle 20, achieving damping and effort-saving effects.

Further, the recessed portions 16 can be directly easily formed on the head 10 by using machining tool, and thus the fabrication of the shock absorbing hammer 1 is quite simple. Unlike the prior art design that needs to make holes through the head 10, the formation of the recessed portions 16 on the cheeks 12 of the head 10 does not significantly affect the structural strength of the head 10, and thus, the lifespan of the shock absorbing hammer 1 can be extended.

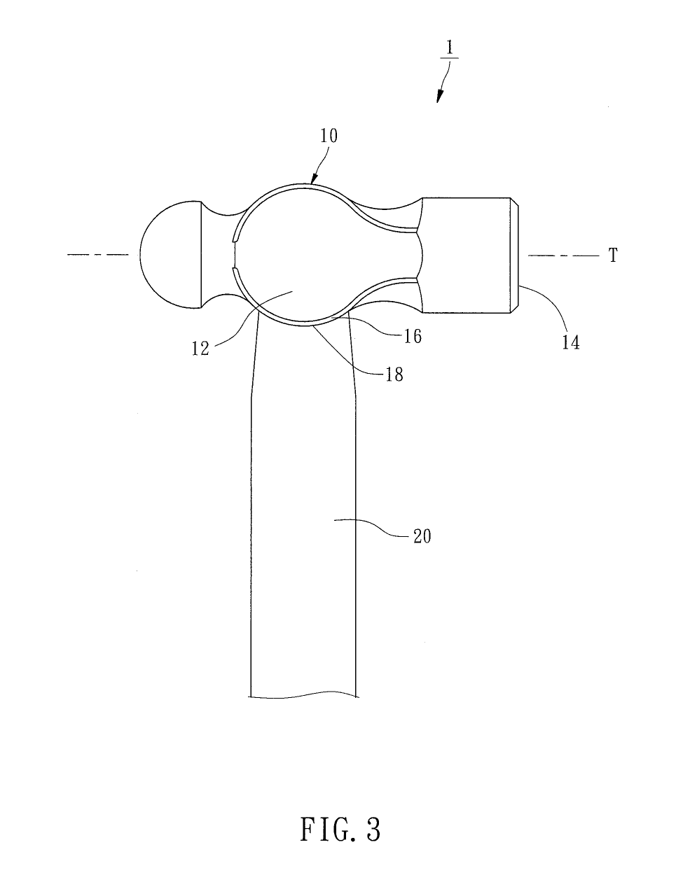

The invention can also be applied to a ball-peen hammer. In the second embodiment of the present invention, as illustrated in FIG. 3, the structure of the shock absorbing hammer 1 is substantially similar to the aforesaid first embodiment with the exception that the edge 18 is smoothly arched.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A shock absorbing hammer, comprising a head and a handle connected to said head, characterized in that said head comprises at least one recessed portion located on an edge of said head and abutted to said handle.

2. The shock absorbing hammer as claimed in claim 1, wherein said at least one recessed portion has a stepped cross section.

3. The shock absorbing hammer as claimed in claim 1, wherein said head comprises two opposite cheeks; the number of said at least one recessed portion is two, and the two said recessed portions are respectively located on said two cheeks.
